(19) United States
(12) Patent Application Publication
(10) Pub. No.: US 2002/0059615 A1
(43) Pub. Date: May 16, 2002

(54) Cable broadcasting system, and head end unit and indoor unit to be used therein

(76) Inventors: Hidekata Okawara, Nisshin-shi (JP); Masahiro Otsu, Nisshin-shi (JP)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/499,186

(22) Filed: Feb. 7, 2000

(30) Foreign Application Priority Data
Feb. 8, 1999 (JP) 11-30576

(51) Int. Cl. H04N 7/18; H04N 7/173

(52) U.S. Cl. 725/78; 725/81

(57) ABSTRACT

A cable broadcasting system having a simple structure, by which radio telephones can be used in good condition even inside a building, or at any other place where a subscriber's terminal is provided. An existing community receiving system for supplying, to a subscriber's terminal installed in each subscriber's home, broadcasting signals (90-1335 MHz) in VHF, UHF, and BS-IF bands received by respective outdoor antennas is provided with another outdoor antenna for radio waves in a radio telephone frequency band (1429.025-1919.45 MHz) used for cellular phones and PHS terminals, and a radio telephone repeater for transmitting/receiving the radio waves in the radio telephone frequency band. Furthermore, a head end unit in the system is provided with a mixer-extractor such that the signals transmitted/received by the radio telephone repeater can be relayed, via a tap device, to the subscriber's terminal. Consequently, the radio waves transmitted/received by the outdoor antenna can be transmitted/received between the radio telephones and an indoor antenna connected with the subscriber's terminal.

### FIELD OF THE INVENTION

This invention relates to a cable broadcasting system for supplying broadcasting signals, via a transmission line, to a subscriber's terminal installed inside a building, as well as a head end unit and an indoor unit to be used in the cable broadcasting system.

### BACKGROUND OF THE INVENTION

Conventionally, radio telephones, such as cellular telephones, terminal telephones in the Personal Handyphone System (PHS) in Japan (hereinafter called “PHS terminals”), and the like, have been used, and it has been well known that such radio telephones can be used only in the areas where radio waves can reach from a base station. Specifically, since the radio waves sent from the base station outside a building greatly attenuate inside the building, it is difficult to talk over such a radio telephone inside the building, except near the windows. In especial, the PHS terminals are much influenced by the attenuation inside the building since the power of the radio waves transmitted from its base station is weaker. The same problem also happens in a subterranean building, for example, at a subterranean shopping mall, where the radio waves generated above the ground cannot reach. Accordingly, in order for a person who is inside a building to use a radio telephone, it is necessary that he/she should move to any place where radio waves can reach from a base station, which is very troublesome and inconvenient.

On the contrary, it has recently become possible to use the radio telephones inside a building by providing a base station in such a place. However, in order to make the radio telephones useable, for example, in all the rooms of an apartment building in the aforementioned way, a new base station must be provided in each room of the apartment building, which would result in a large amount of investment.

### SUMMARY OF THE INVENTION

The present invention was made to solve the aforementioned problems. Specifically, the object of the present invention is to provide a simple system in which radio telephones can be used in good condition even inside a building including a subterranean building.

In order to attain this object, as a result of various examinations, the inventors directed their attention to a cable broadcasting system, such as a CATV system (including a community receiving system), for supplying broadcasting signals, such as television signals, via a transmission line made of a coaxial cable or the like, to a subscriber's terminal installed in each subscriber's home.

In the CATV system, as an example of such a cable broadcasting system, VHF broadcasting signals (90-222 MHz) and UHF broadcasting signals (470-770 MHz), which are TV broadcasting signals transmitted from a ground-based station, as well as BS broadcasting signals (11.7-12 GHz), which are TV broadcasting signals transmitted using a broadcasting satellite, are received with a community antenna. The received BS broadcasting signals are then converted into intermediate frequency (BS-IF) signals (1035-1335 MHz) before being split and supplied to each subscriber's terminal via a transmission line, that is a coaxial cable, while the received VHF and UHF broadcasting signals are directly split and supplied thereto. In this case, a frequency band of transmission signals transmitted via the transmission line (90-1335 MHz) never overlaps the frequency bands of signals transmitted for the typical radio telephones, for example, a frequency band of signals for cellular phones (1429.025-1512.975 MHz) and that for the PHS terminals (1893.65-1919.45 MHz). Consequently, it is possible to transmit the signals for the cellular phones as well as those for the PHS terminals using the transmission line of the CATV system.

Wherefore, the present invention is a cable broadcasting system for supplying broadcasting signals, via a transmission line, to a subscriber's terminal installed inside a building, wherein radio waves in a radio telephone frequency band used for radio telephones are transmitted/received via an outdoor antenna provided outside the building, and wherein signals received from the outdoor antenna are mixed with the broadcasting signals transmitted to the transmission line while the signals in the radio telephone frequency band are extracted from transmission signals on the transmission line to be supplied to the outdoor antenna, whereby the radio waves in the radio telephone frequency band transmitted/received by the outdoor antenna can be transmitted/received even inside the building via an indoor antenna connected with the subscriber's terminal.

In the cable broadcasting system as mentioned above, the radio waves in the radio telephone frequency band transmitted/received by the outdoor antenna are relayed via the transmission line, and then transmitted/received by the indoor antenna. Consequently, radio telephones can be used at any place where a subscriber's terminal is provided, even inside a building.

Furthermore, it is possible to utilize an existing CATV system or the like, so it is not necessary to conduct wiring work for new transmission lines. In addition, it is not necessary, either, to newly provide a base station for radio telephones in each room of an apartment building or the like. As a result, a cable broadcasting system of the present invention can be constructed simply and at a low cost.

However, in cases where, for example, intermediate frequency (CS-IF) signals (1522-2072 MHz) of CS broadcasting signals (12.2-12.75 GHz), which are TV broadcasting signals transmitted using a communications satellite, are used in the existing cable broadcasting system, a frequency band of such CS-IF signals overlaps the frequency band of signals for cellular phones or that for the PHS terminals, which will cause interference between the CS-IF signals and the signals for cellular phones or those for the PHS terminals. Therefore, the existing cable broadcasting systems adaptable to the present invention are only those in which frequency bands lower than that for the radio telephones (lower than that of the BS-IF signals) and/or frequency bands higher than that for the radio telephones are only used.

Now, in constructing a cable broadcasting system according to the present invention, a conventional head end unit for transmitting broadcasting signals to a transmission line may be utilized, simply by adding thereto a mixer-extractor for mixing the signals in the radio telephone frequency band with the broadcasting signals transmitted to the transmission line as well as for extracting the signals in the radio telephone frequency band from the transmission signals on the transmission line.

In the cable broadcasting system comprising such a head end unit, the mixer-extractor may be connected with a transmitter-receiver for transmitting/receiving the radio waves in the radio telephone frequency band via the outdoor antenna provided outside the building, such that the cable broadcasting system according to the present invention can be constructed simply. Specifically, considering the PHS terminals only as the radio telephones, a well-known cell station structured as a base station for the PHS terminals can be utilized as such a transmitter-receiver, and it is thus unnecessary to develop a new transmitter-receiver. In this case, the cable broadcasting system can be constructed more simply.

The transmitter-receiver as well as the mixer-extractor may be incorporated in the head end unit.

Now, the cable broadcasting system according to the present invention may include an indoor unit to be connected with the subscriber's terminal for transmitting/receiving the radio waves in the radio telephone frequency band inside the building, or wherever at least one subscriber's terminal is provided, comprising at least an antenna for transmitting/receiving the radio waves in the radio telephone frequency band, and a terminal-side connector, being connectable with the subscriber's terminal, for inputting/outputting, via the subscriber's terminal, the signals transmitted/received by the antenna.

Furthermore, the indoor unit may comprise an end-side connector for being connected with a subscriber's end utilizing the broadcasting signals and a distributing device for distributing to the antenna and the end-side connector the transmission signals supplied via the terminal-side connector. In this case, by connecting the end-side connector with the subscriber's end, the subscriber's end utilizing the broadcasting signals and a radio telephone transmitting/receiving the radio waves in the radio telephone frequency band can be in use at the same time even if there is only one subscriber's terminal provided indoors.

The indoor unit may be provided with a supporting portion for supporting the antenna, which is rod-like, in a standing state, and the distributing device may be accommodated in the supporting portion. With such structure, the rod-like antenna can be set up simply by putting the supporting portion on a stable place, or simply by fixing the supporting portion on a desired place.

In cases where a supporting portion is provided, the terminal-side connector and the end-side connector may be integrated with the supporting portion. Otherwise, each connector may be provided at a terminal portion of a transmission line extended from the supporting portion.

The antenna may be tiltable relative to the supporting portion. Alternatively, it may be detachably attached to the supporting portion. The indoor unit can thus be stored in a compact space without being obstructed by its antenna.

Furthermore, in the indoor unit according to the present invention, in cases where the antenna is formed in a rod-like shape, the terminal-side connector may be formed integrally with the antenna, at a terminal portion thereof. In this case, simply by connecting the terminal-side connector with the subscriber's terminal, the antenna can be kept in a standing state.

Alternatively, the antenna may have a retractable structure such that it can be retracted when not in use, which also results in a compact storage of the indoor unit.

### BRIEF DESCRIPTION OF THE DRAWINGS

The invention will now be described, by way of example, with reference to the accompanying drawings, in which:

FIG. 1 is a schematic block diagram of a CATV system according to an embodiment of the invention;

FIGS. 2A to 2C are block diagrams showing the structure of each section of the CATV system; more specifically, FIGS. 2A, 2B and 2C are block diagrams showing the structures of a mixer, a mixer-extractor, and a tap device, respectively;

FIG. 3 is an explanatory view illustrating the structure of an indoor unit and the way of use thereof, which is suitable in cases where two subscriber's terminals are available;

FIG. 4A is a block diagram showing the structure of a tap device of an alternate embodiment, and FIG. 4B is a schematic block diagram of a part of a CATV system including the tap devices as shown in FIG. 4A;

FIG. 5 is an explanatory view illustrating the structure of an indoor unit and the way of use thereof, which is suitable in cases where one subscriber's terminal is available;

FIG. 6 is an explanatory view illustrating the structure of an indoor unit of an alternate embodiment and the way of use thereof, which is also suitable in cases where one subscriber's terminal is available;

FIGS. 7A and 7B are block diagrams showing the internal structures of supporting portions of the indoor units as illustrated in FIGS. 5 and 6, respectively; and

FIGS. 8A, 8B and 8C are block diagrams showing a few examples of the structures of mixers.

### DETAILED DESCRIPTION OF THE PREFERRED EMBODIMENTS

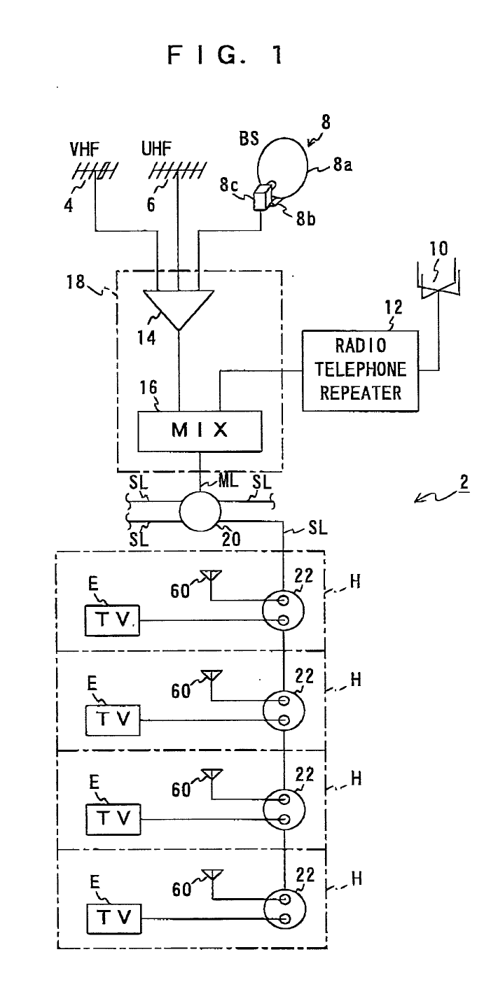

As shown in FIG. 1, a CATV system 2 of the embodiment, what is called a community receiving system for transmitting to each home signals received by an outdoor antenna set up outside an apartment building or the like, includes, as outdoor antennas for reception of TV broadcasting signals, a VHF antenna 4 and a UHF antenna 6 (hereinafter generically called “ground-based antennas”) for receiving, respectively, TV broadcasting radio waves in a VHF band (90-222 MHz) and those of a UHF band (470-770 MHz) transmitted from a ground-based station and a BS antenna 8 for receiving radio waves (11.7-12 GHz) transmitted from a broadcasting satellite (BS).

The BS antenna 8 comprises a reflector 8a and a receiving portion 8c disposed, via a supporting arm 8b, at the position of a focus of the reflector 8a. The receiving portion 8c converts transmission radio waves, which are transmitted from the BS and collected by the reflector 8a, into BS-IF signals in an intermediate frequency (BS-IF) band (1035-1335 MHz), and then outputs the converted signals.

Also, the CATV system 2 includes an outdoor antenna (hereinafter called “radio telephone antenna”) 10 for radio waves in frequency bands used in the cellular telephone system (1429.025-1512.975 MHz) and the PHS (1893.65-1919.45 MHz) (hereinafter generically called “radio telephone frequency band”) and a radio telephone repeater 12 for transmitting/receiving, via the radio telephone antenna 10, the radio waves in the radio telephone frequency band.

Furthermore, the CATV system 2 includes a head end unit 18, a splitter 20 and a tap device (what is called “tap off”) 22. The head end unit 18 comprises a mixer 14 for mixing the signals received by the ground-based antennas 4 and 6 with the BS-IF signals to output broadcasting signals (90-1335 MHz) and a mixer-extractor 16 for mixing the broadcasting signals from the mixer 14 with the signals received from the radio telephone repeater 12 to transmit the mixed signals to a main transmission line ML as well as for extracting the signals in the radio telephone frequency band from transmission signals on the main transmission line ML to supply the extracted signals to the radio telephone repeater 12. The splitter 20 splits the transmission signals on the main transmission line ML into a plurality of sub-transmission lines SL. The tap device 22 provided in each subscriber's home H distributes the transmission signals on a sub-transmission line SL such that part of the signals are drawn into the respective subscriber's home H.

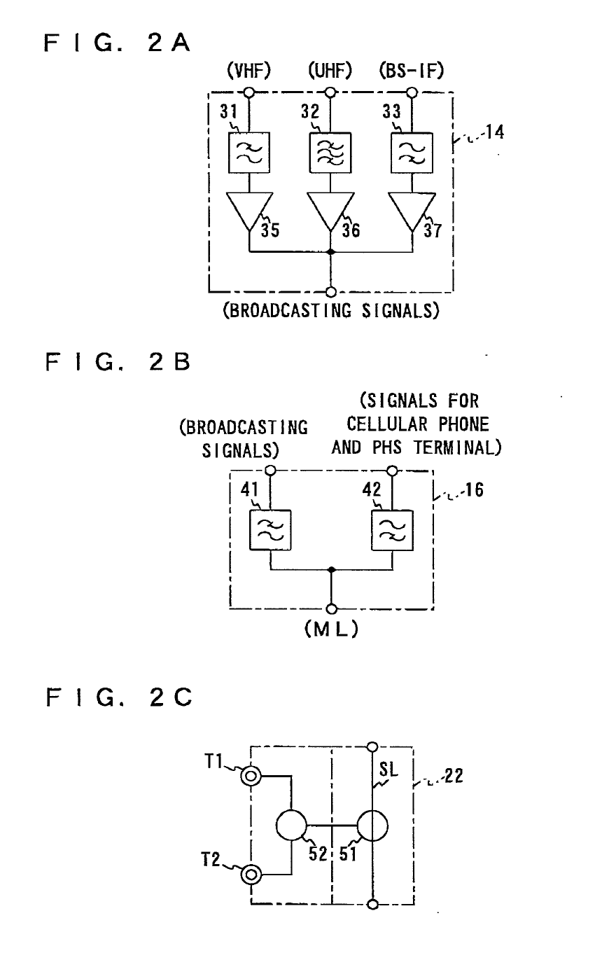

As shown in FIG. 2A, the mixer 14, a constituent member of the head end unit 18, comprises a low pass filter (LPF) 31, a band pass filter (BPF) 32, a high pass filter (HPF) 33, and amplifiers 35 to 37. The LPF 31 removes from the signals received by the VHF antenna 4 undesired elements, such as noise, having frequencies higher than those included in the VHF band. The BPF 32 removes from the signals received by the UHF antenna 6 undesired elements having frequencies not included in the UHF band. The HPF 33 removes from the BS-IF signals undesired elements having frequencies lower than those included in the BS-IF band. The amplifiers 35, 36 and 37 amplify the outputs from the filters 31, 32 and 33, respectively. The mixer 14 mixes the outputs from the amplifiers 35, 36 and 37, and then outputs the mixed outputs as broadcasting signals.

The mixer-extractor 16, another constituent member of the head end unit 18, as shown in FIG. 2B, comprises an LPF 41 for removing from the broadcasting signals transmitted from the mixer 14 undesired elements having frequencies higher than those included in a frequency band of the broadcasting signals and an HPF 42 for removing from the signals received from the radio telephone repeater 12 undesired elements having frequencies lower than those included in the radio telephone frequency band. The mixer-extractor 16 mixes the outputs from each filter 41, 42, and then transmits the mixed outputs to the main transmission line ML. In addition, the HPF 42 is bi-directionally usable, by which the transmission signals from the main transmission line ML are supplied to the radio telephone repeater 12 with undesired elements having frequencies lower than those included in the radio telephone frequency band removed therefrom.

The tap device 22 provided on the sub-transmission line SL, as shown in FIG. 2C, comprises a directional coupler 51 for branching part of the transmission signals on the sub-transmission line SL and a splitter 52 for equally splitting the output from the directional coupler 51 into a pair of subscriber's terminals T1 and T2 installed in a subscriber's home H. The directional coupler 51 and the splitter 52 are both capable of bi-directionally transmitting the transmission signals (at least those in the radio telephone frequency band). Specifically, the splitter 52 is capable of supplying to the directional coupler 51 the signals from the subscriber's terminals T1 and T2, while the directional coupler 51 is capable of supplying to the sub-transmission line SL the signals from the splitter 52.

In the aforementioned CATV system 2, the signals in the VHF and UHF bands received by the ground-based antennas 4 and 6, respectively, and the signals in the BS-IF band converted from the signals received by the BS antenna 8 are all mixed together at the head end unit 18, and then supplied to the subscriber's terminals T1 and T2 via the main transmission line ML, the splitter 20, the sub-transmission line SL and the tap device 22.

Also, the signals in the radio telephone frequency band received, via the radio telephone antenna 10, at the radio telephone repeater 12 are mixed with the broadcasting signals at the head end unit 18, and then supplied to the subscriber's terminals T1 and T2 via the main transmission line ML, the splitter 20, the sub-transmission line SL and the tap device 22 in the same manner as the broadcasting signals. On the contrary, the signals in the radio telephone frequency band input from the subscriber's terminals T1 and T2 are supplied to the radio telephone repeater 12 via the tap device 22, the sub-transmission line SL, the splitter 20, the main transmission line ML and the head end unit 18, and then transmitted to the outside via the radio telephone antenna 10. That is, the signals in the radio telephone frequency band are bi-directionally relayed between the radio telephone antenna 10 set up outside and the subscriber's terminal T1, T2 installed in each subscriber's home H.

Accordingly, in the CATV system 2 of the embodiment, the signals in the radio telephone frequency band transmitted/received via the radio telephone antenna 10 set up outdoors can be transmitted/received via an antenna of an indoor unit 60, and at the same time, TV broadcasting can be enjoyed as usual in each subscriber's home H, when the indoor unit 60 having the antenna for transmitting/receiving the radio waves in the radio telephone frequency band is connected with one subscriber's terminal T1 and a TV receiver E, or the like, utilizing the broadcasting signals is connected with the other subscriber's terminal T2. As a result, a radio telephone, such as a cellular phone or a PHS terminal, can be used in good condition even inside the subscriber's home H where the subscriber's terminal T1 is installed.

Also, the CATV system 2 can be constructed extremely simply and at a low cost by utilizing a conventional CATV system for community receiving. Specifically, the CATV system 2 can be constructed only by partly remodeling a head end unit in the conventional system (that is, by adding thereto the mixer-extractor 16) and by providing the conventional system with the radio telephone antenna 10 and the radio telephone repeater 12.

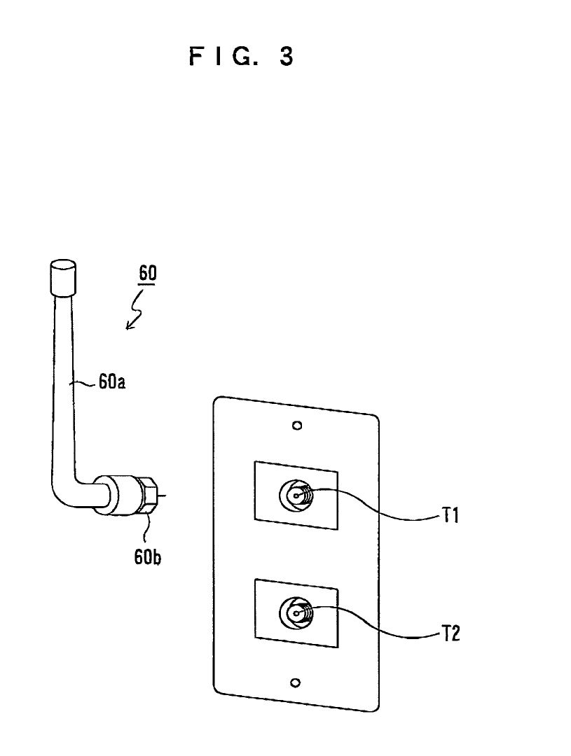

Now, as in the aforementioned embodiment, in cases where a plurality of subscriber's terminals T1 and T2 are installed in a subscriber's home H, either of the subscriber's terminals T1 and T2 can be used exclusively for the radio telephones. Accordingly, a unit, as shown in FIG. 3, comprising a rod-like antenna 60a and a connector 60b formed integrally with the antenna 60a can preferably be used as the indoor unit 60. The antenna 60a is bent at an angle of approximately 90° in the vicinity of the connector 60b. The connector 60b can be detachably attached to the subscriber's terminal.

The indoor unit 60 having such structure can be set in a compact space since the antenna 60a is fixed in a standing state along the wall on which the subscriber's terminals are provided, simply by connecting the connector 60b with either of the subscriber's terminals T1 and T2.

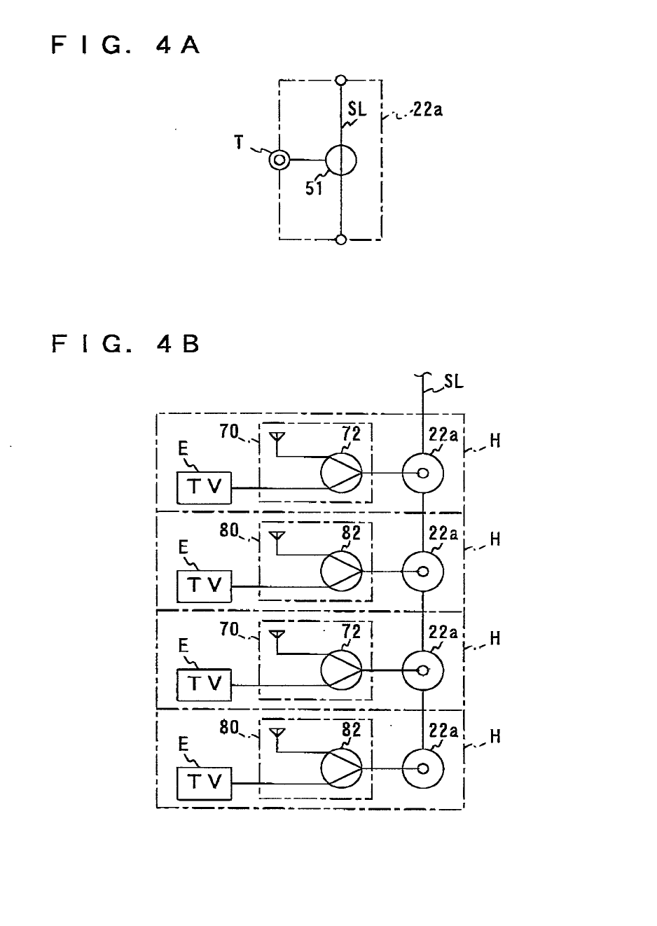

Now, in cases where a single subscriber's terminal T is only installed in each subscriber's home H, for example, a tap device 22a, as shown in FIG. 4A, comprising the directional coupler 51 for branching part of the transmission signals on the sub-transmission lines SL is applicable. In this case, as shown in FIG. 4B, indoor units 70 and 80, having built-in branching filters 72 and 82, respectively, for filtering the transmission signals supplied from the subscriber's terminal T, are preferably useable.

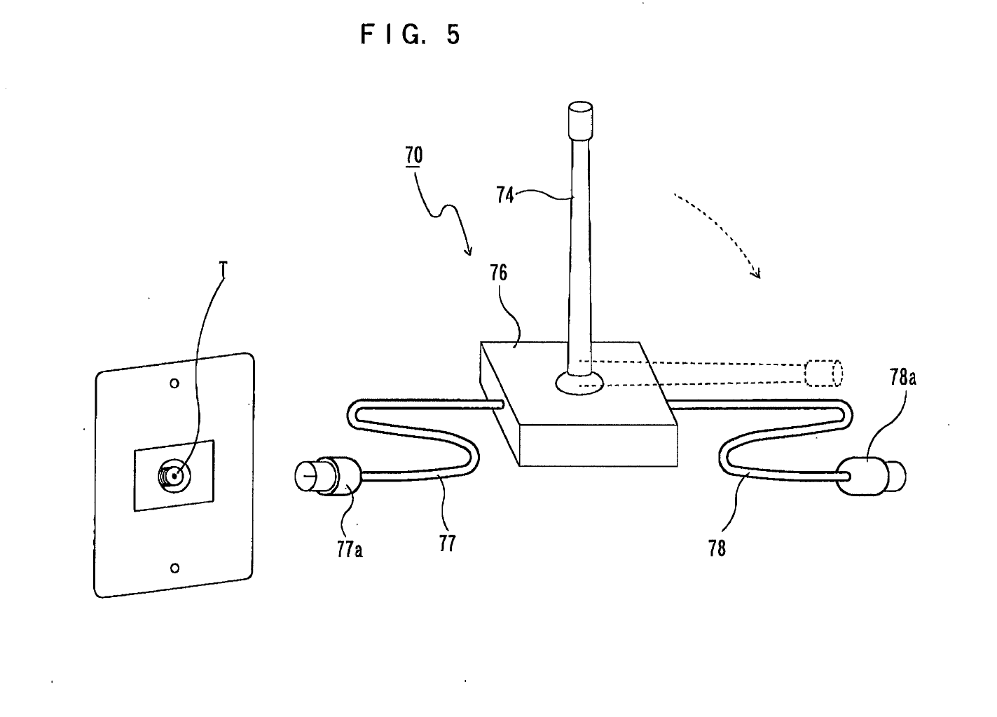

The indoor unit 70, as shown in FIG. 5, has a supporting base 76 for supporting a tiltable rod-like antenna 74. The branching filter 72 is built in the supporting base 76 and a terminal-side cable 77 and an end-side cable 78 are extended therefrom. Provided at a terminal portion of the terminal-side cable 77 is a terminal-side connector 77a for connection with the subscriber's terminal T, and provided at a terminal portion of the end-side cable 78 is an end-side connector 78a for connection with an subscriber's end E, such as a TV receiver, utilizing the broadcasting signals.

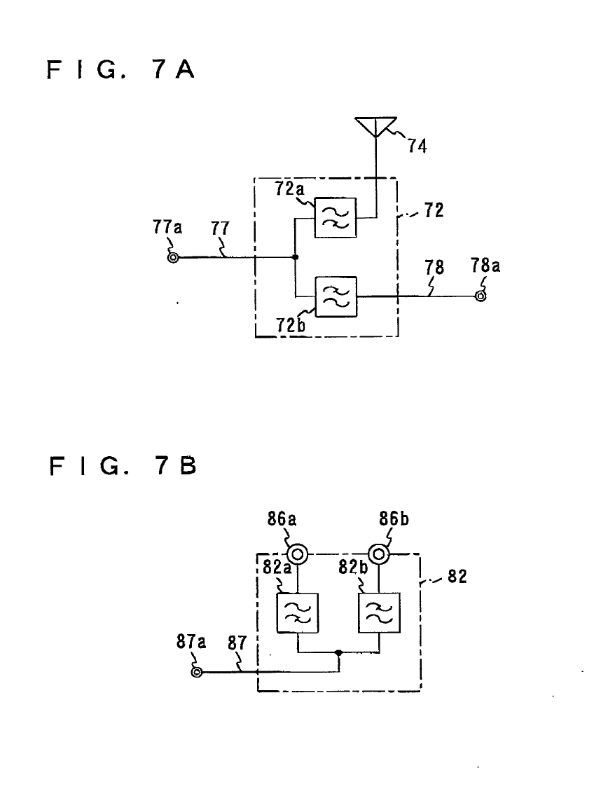

The branching filter 72, as shown in FIG. 7A, comprises an HPF 72a by which the signals in the radio telephone frequency band are extracted from the transmission signals supplied, via the terminal-side cable 77, from the terminal-side connector 77a connected with the subscriber's terminal T to be supplied to the antenna 74, and an LPF 72b by which the signals in the frequency band of the broadcasting signals are extracted from the aforementioned transmission signals to be supplied, via the end-side cable 78, to the subscriber's end E connected with the end-side connector 78a.

In addition, the HPF 72a is capable of bi-directional transmission such that undesired elements having frequencies lower than those included in the radio telephone frequency band are removed from the signals received by the antenna 74, and then the rest of the signals are only supplied to the terminal-side cable 77 (and subsequently to the terminal-side connector 77a).

By using the indoor unit 70 having such structure, transmission/reception of the radio waves in the radio telephone frequency band by the antenna 74 as well as supply of the broadcasting signals to the subscriber's end E via the end-side cable 78 (and the end-side connector 78a) can be conducted at the same time even in cases where one subscriber's terminal T is only installed.

Also, the indoor unit 70 can be stored in a compact space without being obstructed by the antenna 74 at the time of storage, since the antenna 74 is tiltable.

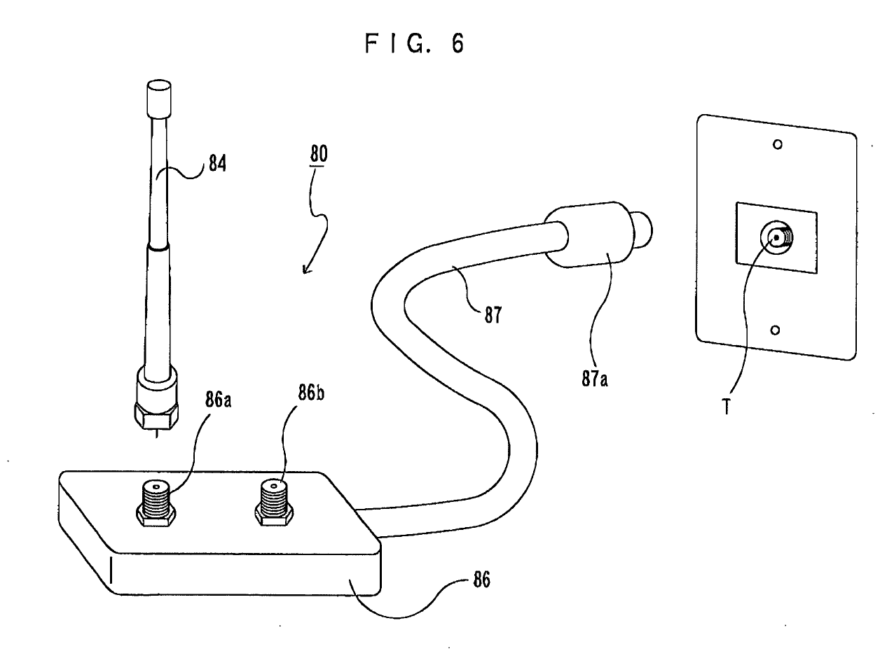

On the other hand, in the indoor unit 80, as shown in FIG. 6, a terminal-side cable 87, at a terminal portion of which a terminal-side connector 87a is provided, is connected with a side face of a supporting base 86 and an antenna attachment connector 86a and an end-side cable attachment connector 86b are both provided on the top face of the supporting base 86. An antenna 84 and an end-side cable (not shown) are each provided with a connector which can be detachably attached to the connectors 86a and 86b, respectively. The antenna 84 also has a retractable structure.

The branching filter 82 built in the supporting base 86, as shown in FIG. 7B, comprises an HPF 82a by which the signals in the radio telephone frequency band are extracted from the transmission signals supplied, via the terminal-side cable 87, from the terminal-side connector 87a connected with the subscriber's terminal T to be supplied to the antenna attachment connector 86a, and an LPF 82b by which the signals in the frequency band of the broadcasting signals are extracted from the aforementioned transmission signals to be supplied to the end-side cable attachment connector 86b.

By using the indoor unit 80 having such structure, as in case of the indoor unit 70, transmission/reception of the radio waves in the radio telephone frequency band by the antenna 84 connected with the connector 86a as well as supply of the broadcasting signals to the subscriber's end E via the end-side cable (and the end-side connector) connected with the connector 86b can be conducted at the same time even in cases where one subscriber's terminal T is only installed.

Also, the indoor unit 80 can be stored in a compact space without being obstructed by the antenna 84 in particular at the time of storage, since the antenna 84 and the end-side cable are detachably attachable, and the antenna 84 is also retractable.

In the indoor unit 80 of the embodiment, the terminal-side cable 87 is fixed to the supporting base 86, however, the terminal-side cable 87 may also be provided as a detachably attachable member.

The preferred embodiments of the present invention have been described as above, however, the present invention is not restricted to such embodiments and may be practiced or embodied in still other ways without departing from the subject matter thereof.

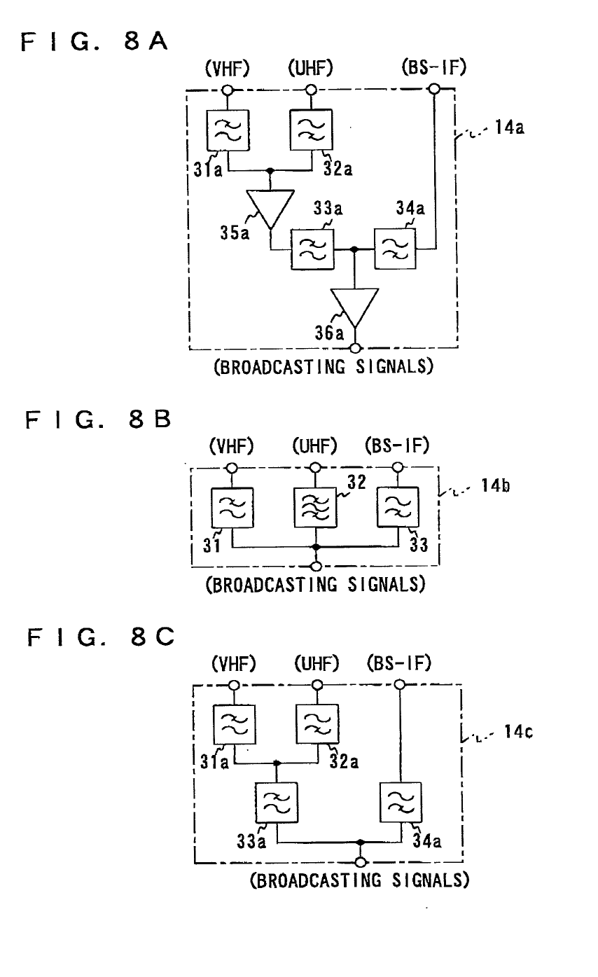

For example, in the aforementioned embodiments, the mixer 14 of the head end unit 18 is composed of three filters 31, 32, 33 and three amplifiers 35, 36, 37. However, it is possible to comprise a mixer with structure of a mixer 14a, as shown in FIG. 8A, as an example. In this mixer 14a, the output from an LPF 31a, which can pass only the signals having frequencies equal to or lower than those included in the VHF band, and the output from an HPF 32a, which can pass only the signals having frequencies equal to or higher than those included in the UHF band, are mixed with one another, and then amplified by an amplifier 35a. Subsequently, in the mixer 14a, the output from an LPF 33a, which can pass only the signals having frequencies equal to or lower than those included in the UHF band out of the output from the amplifier 35a, and the output from an HPF 34a, which can pass only the signals having frequencies equal to or higher than those included in the BS-IF band out of the BS-IF signals output from a receiving portion of a BS antenna, are mixed with one another, and then the mixed outputs are amplified by an amplifier 36a, thereby producing the mixtures of three kinds of signals, that is, the broadcasting signals.

Also, in cases where the power of the signals obtained from each of the antennas 4, 6 and 8 is sufficiently strong, or in cases where the output from each of the antennas 4, 6 and 8 is amplified before being supplied to the head end unit 18, the amplifiers 35, 36 and 37 may be eliminated from the structure of the mixer 14 shown in FIG. 2A, or the amplifiers 35a and 36a may be eliminated from the structure of the mixer 14a shown in FIG. 8A. The former structure is shown in FIG. 8B as structure of a mixer 14b and the latter is in FIG. 8C as structure of a mixer 14c.

Furthermore, in the aforementioned embodiments, the radio telephone repeater 12 is provided as a body separated from the head end unit 18, however, it may be integrated into the head end unit 18.

Furthermore, the indoor unit to be connected with the subscriber's terminal may be built in the subscriber's end, such as a TV receiver or the like, utilizing the broadcasting signals.

In the above description of the embodiments, cellular telephones and the PHS terminals are referred to as examples of radio telephones, however, the present invention is also adaptable to, for example, international cellular telephones in a system called International Mobile Telecommunication 2000 (IMT 2000), for which a frequency band of 1885-2026 MHz will be used in the future.

Wherefore, I/we claim:

1. A cable broadcasting system for supplying broadcasting signals, via a transmission line, to a subscriber's terminal installed inside a building, wherein
radio waves in a radio telephone frequency band used for radio telephones are transmitted/received via an outdoor antenna provided outside the building, and wherein
signals received from said outdoor antenna are mixed with said broadcasting signals transmitted to said transmission line while the signals in said radio telephone frequency band are extracted from transmission signals on said transmission line to be supplied to said outdoor antenna, whereby
the radio waves in said radio telephone frequency band transmitted/received by said outdoor antenna can be transmitted/received even inside the building via an indoor antenna connected with said subscriber's terminal.

2. A head end unit to be provided in the cable broadcasting system as recited in claim 1, for transmitting said broadcasting signals to said transmission line, comprising
a mixer-extractor for mixing the signals in said radio telephone frequency band with said broadcasting signals transmitted to said transmission line as well as for extracting the signals in said radio telephone frequency band from said transmission signals on said transmission line.

3. The head end unit as recited in claim 2, further comprising a transmitter-receiver for transmitting/receiving the radio waves in said radio telephone frequency band via said outdoor antenna provided outside the building, wherein said mixer-extractor mixes/extracts the signals transmitted/received by said transmitter-receiver with/from said transmission signals.

4. An indoor unit to be connected with said subscriber's terminal in the cable broadcasting system as recited in claim 1, comprising:
an antenna for transmitting/receiving the radio waves in said radio telephone frequency band; and
a terminal-side connector, being connectable with said subscriber's terminal, for inputting/outputting, via said subscriber's terminal, the signals transmitted/received by said antenna.

5. The indoor unit as recited in claim 4, further comprising an end-side connector for being connected with a subscriber's end utilizing said broadcasting signals and a distributing device for distributing to said antenna and said end-side connector the transmission signals supplied via said terminal-side connector.

6. The indoor unit as recited in claim 5, further comprising a supporting portion for accommodating said distributing device and supporting said antenna, wherein said antenna is formed in a rod-like shape and supported by said supporting portion in a standing state.

7. The indoor unit as recited in claim 6, wherein said antenna is tiltable relative to said supporting portion.

8. The indoor unit as recited in claim 6, wherein said antenna is detachably attached to said supporting portion.

9. The indoor unit as recited in claim 4, wherein said antenna is formed in a rod-like shape and said terminal-side connector is formed integrally with said antenna at a terminal portion thereof.

10. The indoor unit as recited in claim 6, wherein said antenna is retractable.

11. The indoor unit as recited in claim 9, wherein said antenna is retractable.
